(19) United States
(12) Patent Application Publication
(10) Pub. No.: US 2018/0084017 A1
(43) Pub. Date: Mar. 22, 2018

(54) INTELLIGENT HAND-OFF ACROSS MULTIPLE MODALITIES DURING CONTENT PLAYBACK

(71) Applicant: Apple Inc., Cupertino, CA (US)

(72) Inventors: Daniel R. Borges, Cupertino, CA (US); Michael J. Giles, Cupertino, CA (US); Craig P. Dooley, Cupertino, CA (US)

(73) Assignee: Apple Inc., Cupertino, CA (US)

(21) Appl. No.: 15/708,908

(22) Filed: Sep. 19, 2017

Related U.S. Application Data
(60) Provisional application No. 62/397,006, filed on Sep. 20, 2016.

(51) Int. Cl. H04L 29/06

(52) U.S. Cl. CPC H04L 65/4069; H04L 65/1069

(57) ABSTRACT

Intelligent handoff across different content modalities during streaming of content is discussed herein. Content modalities represent different mechanisms by which content may be streamed to a playback device and include transport modality, source modality, and playback modality. Electronic devices may detect, a change in an operating condition of the streaming content and may make a determination as to whether the change triggers a hand-off involving one or more of these modalities.

### CROSS-REFERENCE TO RELATED APPLICATION

This application claims the benefit of U.S. Provisional Application No. 62/397,006, titled “Intelligent Hand-Off Across Multiple Modalities During Content Playback,” filed on Sep. 20, 2016, which is incorporated by reference in its entirety.

### BACKGROUND

### Field

This disclosure generally relates to techniques for performing intelligent hand-off across different modalities during content playback.

### Related Art

In today's world, consumers have numerous options for accessing and enjoying content. For example, to access content, consumers may choose from a wide range of transport mediums, such as a Bluetooth™ wireless connection, a local area network connection (such as an Ethernet™ or WiFi™), or a cellular network connection (e.g., a 3G/4G network such as UMTS or LTE), that deliver content to the consumer. Moreover, consumers may choose from different sources from which to access content, including from network locations, from peer devices, or from a local storage location. To consume content, consumers also have a wide variety of electronic devices from which to choose, ranging from electronic devices that playback content to electronic devices that allow both playback and content delivery to or from other electronic devices.

### SUMMARY

The described embodiments relate to intelligent hand-off techniques across multiple modalities during content playback. A modality may refer to a particular mode for how content is accessed by or delivered to a consumer of the content. For example, a content modality may include a transport modality (e.g., different transport mediums for delivering content), a source modality (e.g., different electronic devices that act as sources for delivering content), and a playback modality (e.g., different electronic devices that may play or access delivered content).

Some embodiments relate to a method for performing a source modality hand-off for streaming content where a content stream is transitioned from a first source device to a second source device. The method includes the following: (i) transmitting first content from a first source device to a playback device over a first connection; (ii) detecting a change in an operating condition of at least one of the first connection, the playback device, the first source device, and a second source device, wherein the second source device has access to second content; (iii) based on at least detecting the change in the operating condition, transitioning from the first source device to the second source device, to transmit the second content to the playback device, wherein the transitioning includes utilizing a second connection between the playback device and the second source device; and (iv) transmitting the second content from the second source device to the playback device over the second connection at a point in the first content corresponding to the transitioning from the first source device to the second source device.

Some embodiments relate to a method for performing a transport medium modality hand-off for streaming content where a content stream is transitioned from a first connection with a source device to a second connection to the source device. The method includes the following: (i) transmitting content from a source device to a playback device over a first connection; (ii) detecting a change in an operating condition of at least one of the first connection, the playback device, and the source device; (iii) based on at least detecting the change in the operating condition, transitioning from the first connection to a second connection, wherein the transitioning includes utilizing the second connection between the playback device and the source device; and (iv) transmitting the content from the source device to the playback device over the second connection at a point in the content corresponding to the transitioning from the first connection to the second connection.

Some embodiments relate to a method for performing a playback modality hand-off for streaming content where a content stream is transitioned from a first playback device to a second playback device. The method includes the following: (i) transmitting content from a source device to a first playback device over a first connection; (ii) detecting a change in an operating condition of at least one of the first connection, the first playback device, the source device, and a second playback device; (iii) based on at least detecting the change in the operating condition, determining that the content is to be streamed from the source device to the second playback device; (iv) based on at least determining that the content is to be streamed from the source device to the second playback device, transitioning to transmitting the content from the first playback device to the second playback device to receive the content from the source device, wherein the transitioning includes utilizing a second connection between the second playback device and the source device; and (v) transmitting the content from the source device to the second playback device over the second connection at a point in the content corresponding to the transitioning.

This Summary is provided merely for purposes of illustrating some embodiments to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the presented disclosure and, together with the description, further serve to explain the principles of the disclosure and enable a person of skill in the relevant art(s) to make and use the disclosure.

FIG. 1 is a diagram that illustrates an example system implementing modality hand-offs, according to some embodiments of the disclosure.

FIG. 2 illustrates a flowchart for modality hand-offs, according to some embodiments of the disclosure.

FIG. 3A is a block diagram that illustrates an example system implementing a source modality hand-off, according to some embodiments of the disclosure.

FIG. 3B is a block diagram that illustrates an example system implementing a transport medium modality hand-off, according to some embodiments of the disclosure.

FIG. 3C is a block diagram that illustrates an example system implementing a playback modality hand-off, according to some embodiments of the disclosure.

FIG. 4 illustrates example timing and signaling of a source modality hand-off, according to some embodiments of the disclosure.

FIG. 5 illustrates example timing and signaling of a transport medium modality hand-off, according to some embodiments of the disclosure.

FIG. 6 illustrates example timing and signaling of a playback modality hand-off, according to some embodiments of the disclosure.

FIG. 7 illustrates a flowchart of an example source modality hand-off, according to some embodiments of the disclosure.

FIG. 8 illustrates a flowchart of an example transport medium modality hand-off, according to some embodiments of the disclosure.

FIG. 9 illustrates a flowchart of an example playback modality hand-off, according to some embodiments of the disclosure.

FIG. 10 illustrates a flowchart of an example content modality hand-off, according to some embodiments of the disclosure.

FIG. 11 is an example computer system useful for implementing some embodiments or portion(s) thereof.

The presented disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

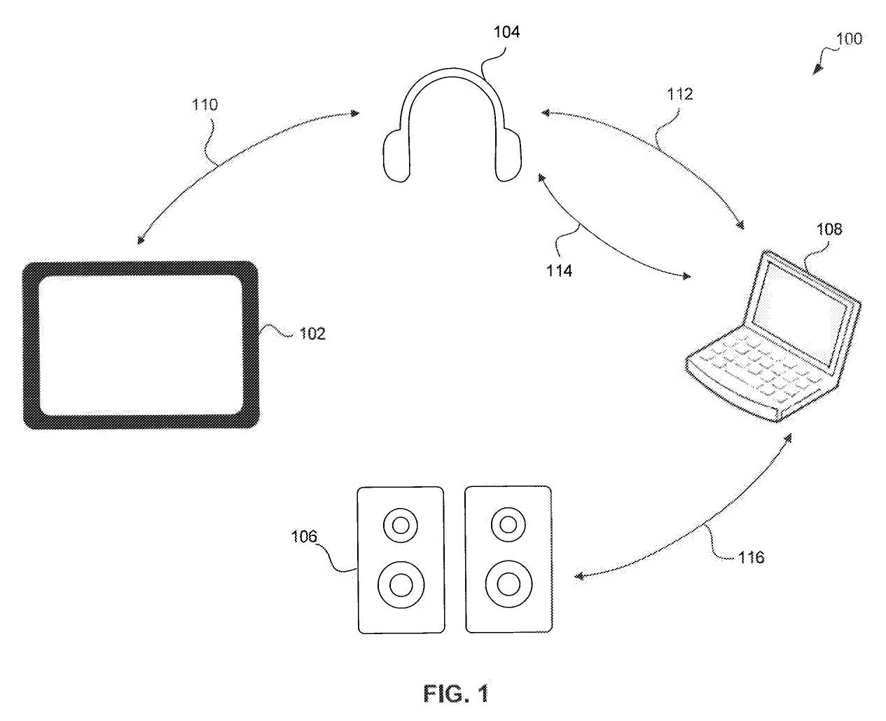

FIG. 1 is a diagram that illustrates system 100, according to some embodiments of the disclosure. System 100 may include a tablet 102, headphones 104, speakers 106, and a laptop 108. In the example of FIG. 1, tablet 102 and laptop 108 may be considered source devices as they may store and/or provide access to content. Headphones 104 and speakers 106 may be considered playback devices as they may playback content streamed from source devices; tablet 102 and laptop 108 may also be considered playback devices when they playback content streamed from other source devices. It is to be appreciated that system 100 may include other electronic devices in addition to or in place of the electronic devices illustrated in FIG. 1 without departing from the scope and spirit of this disclosure.

System 100 includes a connection 110 between tablet 102 and headphones 104, connections 112 and 114 between headphones 104 and laptop 108, and connection 116 between laptop 108 and speakers 106. One or all of connections 110, 112, 114, and 116 may be wireless and may include but are not limited to a cellular network connection (such as but not limited to Universal Mobile Telecommunications System (UMTS) or with the Long-Term Evolution (LTE)), a wireless local network connection (such as but not limited to Institute of Electrical and Electronics Engineers (IEEE) 802.11 standard, which is sometimes referred to as Wi-Fi, or based on Bluetooth or Bluetooth Low Energy from the Bluetooth Special Interest Group of Kirkland, Wash.), or another wireless connection. In some embodiments, one or all of connections 110, 112, 114, and 116 may be implemented as wired connections between each device. It is to be appreciated that there may be additional wired or wireless connections between devices in system 100 such as between tablet 102 and laptop 108 or headphones 104 and speakers 106.

In some embodiments, headphones 104 may initially stream content during a streaming session from laptop 108 using connection 112. It is understood that content may include, but is not limited to, music, video, audio books, applications, and games, to name just some examples. During the streaming session, headphones 104 or laptop 108 may determine that it is appropriate to transition streaming of content from laptop 108 to another source device that provides streaming access to the same content. In some embodiments, as used herein, “appropriate” may mean required, preferred, acceptable, correct, advantageous, in accordance with preferences or settings, etc., depending on the circumstances. In some embodiments, there may be a trigger condition that indicates to headphones 104 and/or laptop 108 that a transition from laptop 108 is appropriate in order to continue streaming content. For example, if a value for a performance metric (or metrics) of connection 112 degrades beyond a certain threshold (such as when the distance between headphones 104 and laptop 108 increases) or an operational condition involving laptop 108 reaches a certain level (such as when laptop 108 is being turned off, going to sleep, or has a battery level below a certain threshold), headphones 104 may transition to receiving content from another source, such as tablet 102. Examples of performance metrics include but are not limited to received signal strength indicator (RSSI), throughput, latency, bandwidth, and throughput. As another example, an operational condition may indicate that laptop 108 is about to enter a sleep-mode or shutdown and therefore, another source for streaming the content is needed. In some embodiments, tablet 102 may provide streaming access to the content. Tablet 102 may provide another version of the content (such as content having a higher bit-rate or resolution) or the same content. Accordingly, the streaming session between headphones 104 and laptop 108 may transition to a streaming session between headphones 104 and tablet 102 using connection 110.

In some embodiments, headphones 104 may utilize connection 110 to connect to and stream the same content from tablet 102 at the same playback point at which the streaming session transitioned from laptop 108. Connection 110 may be established between headphones 104 and tablet 102 concurrently with connection 112, or may be established upon detection that connection 112 has degraded or will be disrupted. This handoff between one source of content (e.g., laptop 108) to another source (e.g., tablet 102) may be considered a source modality hand-off.

Returning back to the scenario where headphones 104 are initially streaming content during a streaming session from laptop 108 using connection 112, headphones 104 or laptop 108 may determine that it is appropriate to transition from connection 112 to another connection between headphones 104 and laptop 108. In some embodiments, there may be a trigger condition that indicates to headphones 104 and/or laptop 108 that a transition from connection 112 is appropriate. For example, as discussed above, a trigger condition may include detection that a value for a performance metric (or metrics) of connection 112 has degraded beyond a certain threshold. Another example of a trigger condition is the detection of another available connection (e.g., connection 114) that has better streaming performance (e.g., a value for a performance metric (or metrics) of connection 114 exceeds the corresponding value of connection 112). In some embodiments, connection 114 may be established concurrently with connection 112, or may be established after receiving a trigger condition (e.g., detection that connection 112 has degraded or when connection 114 is determined to provide better streaming performance). Based on the trigger condition, headphones 104 or laptop 108 may determine that a transition from connection 112 to connection 114 is preferred to continue streaming content. The streaming session between headphones 104 and laptop 108 using connection 112 may transition to a streaming session using connection 114 such that the content streams at the same point at which the streaming session transitioned from connection 112 to connection 114. In some embodiments, connection 112 may be a Bluetooth connection and connection 114 may be a Wi-Fi connection. This handoff between two transport mechanisms may be considered a transport modality hand-off,

Again returning back to the scenario where headphones 104 are initially streaming content during a streaming session from laptop 108 using connection 112, headphones 104 or laptop 108 may determine that it is appropriate to transition from headphones 104 to another playback device (e.g., speakers 106). For example, as discussed above, a trigger condition may include detection that a value for a performance metric (or metrics) of connection 112 has degraded beyond a certain threshold or there is an operational condition involving headphones 104 (e.g., headphones 104 going to sleep or being turned off, the battery level of headphones 104 is below a certain threshold, or the user moving to within a certain predetermined proximity of a preferred playback device such as speakers 106), and thus headphones 104 or laptop 108 may determine that speakers 106 are available to stream the content from laptop 108 using connection 116.

Connection 116 may be established concurrently with connection 112, or may be established upon detection that connection 112 has degraded, or upon detecting the operational condition involving headphones 104. The streaming session between headphones 104 and laptop 108 may transition to a streaming session using connection 116 such that the content streams to speakers 106 at the same point at which the streaming session transitioned from connection 112 to connection 116. This handoff between two playback, devices may be considered a playback modality hand-off.

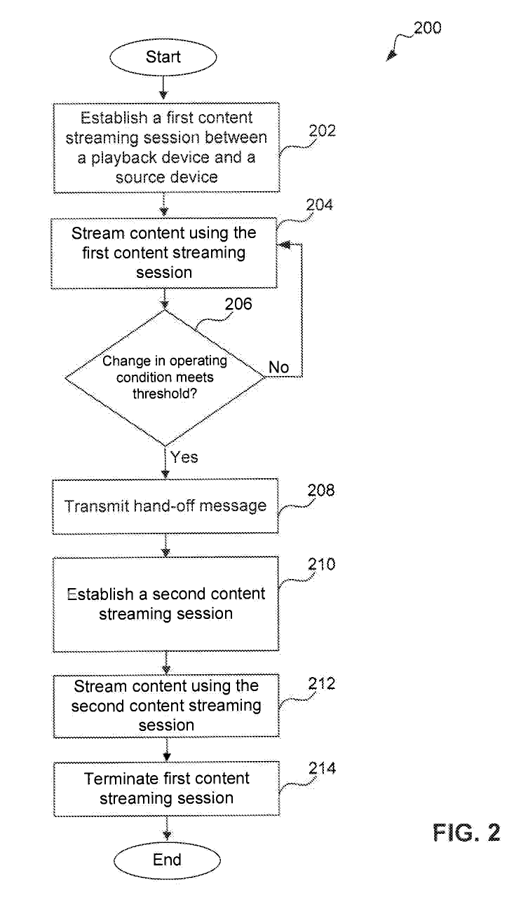

FIG. 2 is a flowchart for an example method 200 For performing a content modality handoff (e.g., transport modality, source modality, and/or playback modality) according to some embodiments. This disclosure is not limited to this operational description. Rather, it will be apparent to persons skilled in the relevant art(s) from the teachings herein that other operational control flows are within the spirit and scope of the present disclosure. It is to be appreciated that additional operations may be performed. Moreover, not all operations may be needed to perform the disclosure provided herein. Further, some of the operations may be performed simultaneously, or in a different order than shown in FIG. 2, as will be understood by a person of ordinary skill in the art. Some operations can be combined with operations of methods from other figures and/or performed as a single operation. In some implementations, one or more other operations may be performed in addition to or in place of the presently described operations. For illustrative purposes, method 200 is described with reference to the embodiment of FIG. 1. However, method 200 is not limited to this embodiment.

At 202, a first content streaming session over connection 112 is established between a playback device such as headphones 104 and a source device, such as laptop 108, having access to content to be streamed to headphones 104. It is to be understood that the playback device may be any device capable of receiving and playing a content stream from a source device and the source device may be any device capable of providing access and streaming content to a playback device.

At 204, laptop 108 may stream content over the first content streaming session using connection 112 to headphones 104. Connection 112 may be implemented as a wireless or wired connection. In some embodiments, laptop 108 and/or headphones 104 may monitor the playback of the streaming content as well as performance metrics associated with connection 112. Monitoring of playback may include tracking the current position as which con lent is being streamed between laptop 108 and headphones 104.

At 206, while laptop 108 streams content to headphones 104, laptop 108 and/or headphones 104 may monitor operating conditions of the first content streaming session. Such monitoring may include monitoring of operations and/or status of laptop 108, operations and/or status of headphones 104, and/or performance metrics of connection 112. If there is no change in operating conditions that would trigger a content modality hand-off, such as a source, transport medium, or playback modality hand-off, content may continue to be streamed using the first content streaming session at 204.

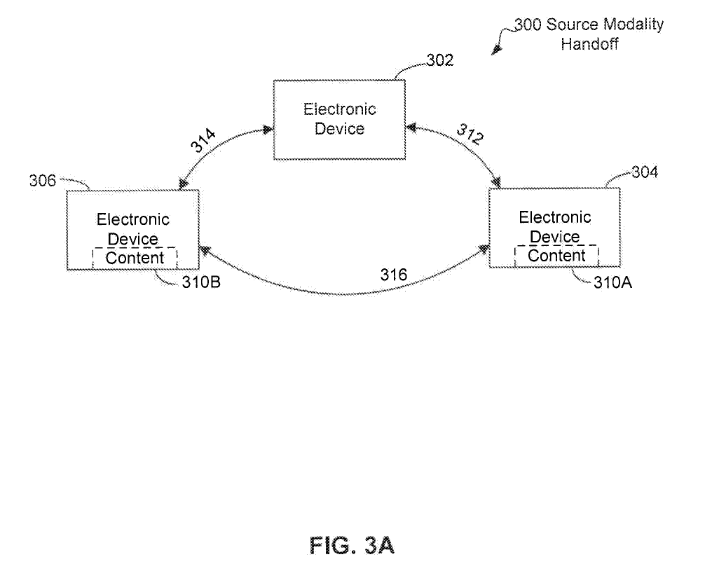

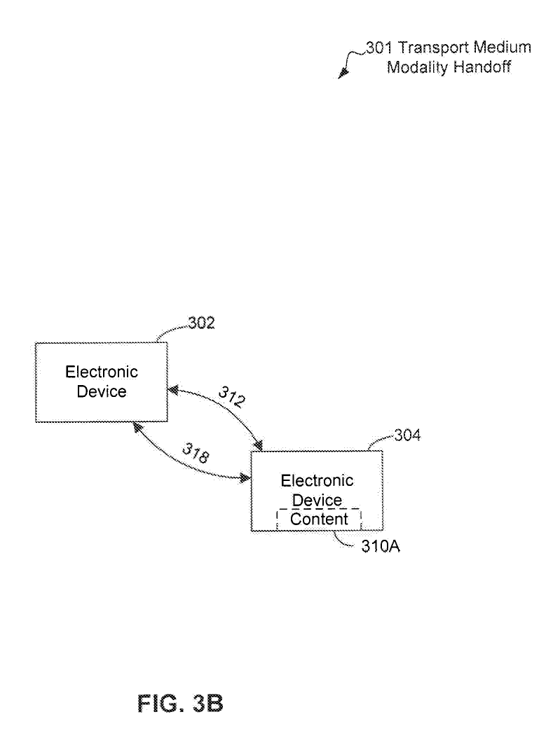

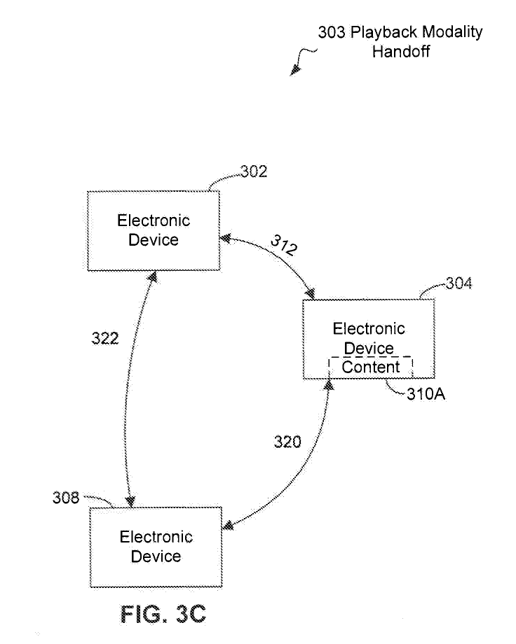

But if laptop 108 and/or headphones 104 at 206 determines a change in operating condition(s) that triggers a content modality hand-off, such as if the change meets a certain predetermined threshold associated with the operating condition(s), then, at 208, a hand-off message may be transmitted to initiate hand-off from the first content streaming session to a second content streaming session. As will be discussed in more detail in FIGS. 3A-8, the content modality hand-off may be a source modality hand-off (where the second content streaming session is between headphones 104 and a different source device such as tablet 102), a transport modality hand-off (where the second content streaming session is between headphones 104 and the same source device, laptop 108), or a playback modality hand-off (where the second content streaming session is between a new playback device, such as speakers 106, and the same source device, laptop 108), or any combination thereof. The second content streaming session depends on the type of modality hand-off. For example, if there is a transport modality hand-off, then the second content streaming session is between the same playback device and same source device over another connection (e.g., connection 114) that is different from the original connection over which the first content streaming session occurred. If there is a source modality hand-off, then the second content, streaming session occurs between the same playback device and a different source device (e.g., tablet 102) over a different connection (e.g., connection 110). If there is a playback modality hand-off, then the second content streaming session occurs between a different, playback device (e.g., speakers 106) and the same source device over a different connection (e.g., connection 116).

Depending on the type of hand-off that is to occur, the band-off message transmitted in 208 may be transmitted by or sent to any device in system 100, such as tablet 102, headphones 104, speakers 106, and/or laptop 108. The hand-off message may include playback information, such as identification of the content currently being streamed over the first content streaming session, a timestamp of content indicating the position at which content is currently being streamed at the time of the hand-off, and an identification of a different connection through which the content may be streamed.

At 210, based on the playback information in the hand-off message, a second content streaming session is established by establishing a second connection. The devices involved in the second connection depend on the type of modality hand-off that is implemented based on the detected changes in operating conditions. For example, if a source modality hand-off is appropriate, then the second connection may be connection 110 between headphones 104 and a second source device such as tablet 102. If a transport medium modality hand-off is appropriate, then the second connection may be connection 114 between headphones 104 and laptop 108. If a playback modality hand-off is appropriate, then the second connection may be connection 116 between speakers 106 and laptop 108.

At 212, content may be streamed over the second content streaming session. Based on the playback information in the hand-off message, the content may be streamed at generally the same point at which the first content streaming session transitioned to second content streaming session in order to provide a seamless playback experience. At 214, the first content streaming session involving connection 112 may be terminated.

Source, transport medium and playback device hand-off modalities according to some embodiments shall now be discussed in greater detail.

FIG. 3A is a block diagram that illustrates system 300, according to some embodiments of the disclosure. System 300 includes electronic device 302, electronic device 304, and electronic device 306. FIG. 3A illustrates a source modality hand-off between electronic device 304 and electronic device 306.

Electronic devices 302, 304, and 306 may be implemented as a playback device and/or a source device such as, but not limited to, set-top boxes, remote controllers, game controllers, wireless headphones, wireless speakers, cellular phones, smart phones, tablets, personal digital assistants (PDAs), wearables, or laptops. According to some embodiments, electronic device 304 may a first source device, such as laptop 108, electronic device 306 may be a second source device, such as tablet 102, and electronic device 302 may be a playback device such headphones 104. As noted above, laptop 108 may be a playback device that streams content from another source device. Accordingly, electronic devices 302, 304, and 306, depending on their respective functions and capabilities, may each be used as a playback device in one content streaming session and a source device in another content streaming session.

Electronic device 304 may provide access to content 310A and electronic device 306 may provide access to content 310B. According to some embodiments, content 310A and 310B may be stored locally in electronic devices 304 and 306, respectively. In other embodiments, electronic devices 304 and 306 may remotely access content 310A and 310B, respectively, using a separate network connection (not illustrated) from another content source such as a remote server or a database. Content 310A and 310B may include but is not limited to audio, video, games, documents, pictures, software, interactive media, multimedia, or any combination thereof. According to some embodiments, content 310A may be the same content (e.g., same TV show or song) as content 310B and having the same playback qualities. Alternatively, in some embodiments, content 310A may have, different playback qualities from content 310B such as having a different bit-rate or different resolution, and/or content 301A may be implemented as different content relative to content 310B (such as different parts of a movie, or different episodes of a TV series, or different songs of an album).

There may be a connection 312 between electronic device 302 and electronic device 304, a connection 314 between electronic device 302 and electronic device 306, and a connection 316 between electronic device 304 and electronic device 306. Connections 312, 314, and 316 allow for the establishment of a content streaming session in which content may be streamed between electronic devices 302, 304, and 306. According to some embodiments, connections 312, 314, and 316 may be implemented using the same or different protocols such as, but not limited to, any one of a cellular network connection (such as hut not limited to Universal Mobile Telecommunications System (UMTS) or with the Long-Term Evolution (LTE)), a wireless local network connection (such as but not limited to Institute of Electrical and Electronics Engineers (IEEE) 802.11 standard, which is sometimes referred to as Wi-Fi, or based on Bluetooth or Bluetooth Low Energy from the Bluetooth Special Interest Group of Kirkland, Wash.), or another wireless connection, and a wired connection. Although not illustrated, connections 312, 314, and 316 may include intermediary networking devices, such as access points, that may facilitate communication between electronic devices 302, 304, and 306. Connections 312, 314, and 316 may be established concurrently with each other or at different times when needed for transmitting content. In an example embodiment, connections 312 and 314 may be Bluetooth connections, connection 316 may be a Bluetooth Low Energy connection, and content 310A and 310B may be streamed using an advanced audio distribution profile (A2DP).

In a streaming session over connection 312, electronic device 302 may initially stream content 310A from electronic device 304. Electronic device 304 may concurrently establish connection 316 with electronic device 306 or may have previously established connection 316. During streaming of content 310A from electronic device 304, electronic device 302 and/or electronic device 304 may detect a change in an operating condition of any of playback of content 310A, connection 312, electronic device 302, electronic device 304, and/or electronic device 306. For example, operating conditions of connection 312 may include, but are not limited to, signal strength or throughput; operating conditions of electronic device 302 may include, but are not limited to, a physical location of electronic device 302, proximity to electronic device 304 and electronic device 306 and physical characteristics (e.g., display size) of electronic device 302, and operating status (e.g., battery-life) of electronic device 302; operating conditions of electronic device 304 may include, but are not limited to, a physical location of electronic device 304, proximity to electronic device 302, operating status (e.g., operating in sleep mode, battery life) of electronic device 304, or the content 310A accessible to electronic device 304; operating conditions of electronic device 306 may include, but are not limited to, a physical location of electronic device 306. proximity to electronic device 302, operating status (e.g., operating in sleep mode, battery life) of electronic device 306, or the content 310B accessible to electronic device 306.

According to some embodiments, the change in the operating condition is compared to a certain threshold associated with the operating condition. For example, the operating condition may indicate that the status of electronic device 304 is changing, that a preferred source device (e.g., electronic device 306) is detected, a preferred content (e.g., better quality) is detected at another source device, and/or the connection associated with electronic device 304 is degrading. Any of these operating conditions may indicate that a change in sources is appropriate in order to continue playback of content 310A.

Accordingly, based on the result of the comparison, the change may trigger a source modality hand-off whereby electronic device 302 transitions streaming of content 310A from electronic device 304 to electronic device 306. In some embodiments, there may be a preference or profile established by a user or the manufacturer of electronic devices 302, 304 and/or 306 that determines whether the change in the operating condition triggers the source hand-off. For example, the preference or profile may indicate a user's preferred source devices, preferred content characteristics and quality (e.g., resolution, bitrate, file size), preferred playback or transmission quality for streaming content over connections (e.g., bandwidth, latency, throughput) and/or thresholds for quality and performance metrics associated with content quality and transmission quality.

If the change in the operating condition triggers a change in the source from which electronic device 302 streams content 310A (e.g., because the change in the operating condition meets a certain threshold), electronic device 302 and/or electronic device 304 may identify the new source for streaming content 310A. For example, electronic device 304 may determine that it is no longer able to support streaming of content 310A to electronic device 302, and may determine that a source hand-off should be performed to electronic device 306, which has access to content 310B. Electronic device 304 may make this determination based on at least the ability of electronic device 302 to establish connection 314 with electronic device 306. As another example, electronic device 302 may determine that content 310B has better playback characteristics than content 310A or playback characteristics that meet the preferences of the user. Therefore, electronic device 302 may determine that a source modality hand-off to electronic device 306 is preferred to access and stream content 310B.

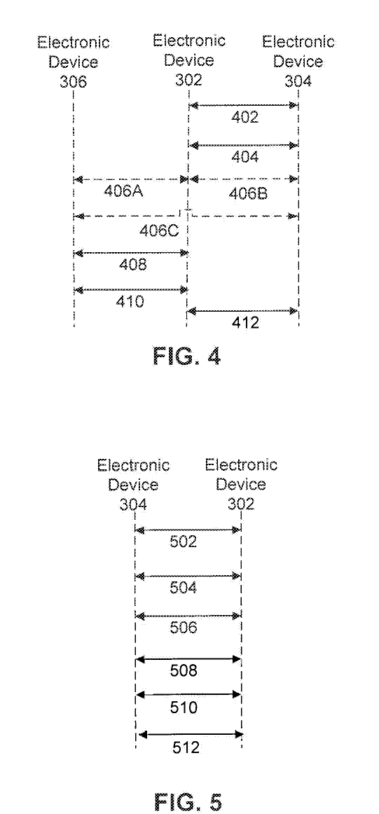

Other examples of thresholds that may trigger a source hand-off include, but are not limited to, electronic device 304 may no longer be able to stream content 310A to electronic device 302 at a certain level (e.g., battery life of electronic device 304 is below a certain threshold, or electronic device 304 is initiating sleep or shut-down functions), electronic device 306 may have a better quality version of content 310B (e.g., bit-rate of audio file accessible to electronic device 306 is higher than bit-rate of audio file accessible to electronic device 304, resolution of video file may be above a certain level such as 480p), or connection 312 to electronic device 304 is becoming unreliable (e.g., signal strength of connection 312 is below a certain threshold). Electronic device 302 and/or electronic device 304 may then identify other sources of content 310A that can potentially stream to electronic device 302 and may select a source (such as electronic device 306) based at least in part on the criteria described above. These determinations are discussed in n ore detail with regard to FIG. 4.

If electronic device 306 is selected as the new source for content 310B, connection 314 between electronic device 302 and electronic device 306 may be established (if not already existing) and may be utilized. Another streaming session may be initiated over connection 314 which allows electronic device 302 to stream content 310B from electronic device 306. Once electronic device 302 begins streaming content 310B from electronic device 306, connection 312 may be terminated.

FIG. 3B is a block diagram that illustrates system 301, according to some embodiments of the disclosure. System 301 includes electronic device 302 and electronic device 304. As will be discussed in more detail below, FIG. 3B illustrates a transport modality hand-off between electronic device 302 and electronic device 304.

As previously discussed with regard to FIG. 3A, electronic device 302 may be considered a playback device such as headphones 104 for retrieving and streaming content 310A from a source device such as electronic device 304, which may be laptop 108. There may be a first connection 312 and a second connection 318 between electronic device 302 and electronic device 304. Connections 312 and 318 allow for the establishment of a content streaming session in which content may be streamed between electronic devices 302 and 304. According to some embodiments, connections 312 and 318 may be implemented using the same or different protocols such as but not limited to a cellular network connection (such as but not limited to UMTS or LTE), a wireless local network connection (such as but not limited to Wi-Fi or based on Bluetooth or Bluetooth Low Energy), or another wireless connection. Although not illustrated, connections 312 and 318 may include intermediary networking devices, such as access points, that may facilitate communications electronic devices 302 and 304. Connections 312 and 318 may be established concurrently with each other or at different times. In an example embodiment, connection 312 may be a Bluetooth connection and connection 318 may be a Wi-Fi or cellular connection.

Electronic device 302 may initially stream content 310A from electronic device 304 via connection 312. During streaming of content 310A, electronic device 302 and/or electronic device 304 may detect a change in an operating condition of connection 312, electronic device 302, and/or electronic device 304. The change in the operating condition may require performing a transport hand-off whereby electronic device 302 streams content 310A from the same source, electronic device 304, but using a different transport medium or connection such as connection 318. As previously noted, there may be a preference or profile established by the user or the manufacturer of electronic devices 302 or 304 that determines whether the change in the operating condition triggers the transport hand-off. For example, preferences may specify thresholds regarding performance metric(s) associated with a connection. Operating conditions include conditions regarding connection 312, connection 318, electronic device 302, and/or electronic device 304. For example, operating conditions of connection 312 and connection 318 may include, but are not limited to, signal strength or throughput; operating conditions of electronic device 302 may include, but are not limited to, a physical location of electronic device 302, and operating status (e.g., running on AC power or battery power, battery life, etc.) of electronic device 302; operating conditions of electronic device 304 may include, but are not limited to, a physical location of electronic device 304, operating status (e.g., running on AC power or battery power, battery life, etc.) of electronic device 304.

If the change in the operating condition triggers a change in the transport medium by which electronic device 302 streams content 310A from electronic device 304 (e.g., because the change in the operating condition meets a certain threshold), electronic device 302 and/or electronic device 304 may determine the new transport medium for streaming content 310A. Examples of thresholds that may trigger a transport hand-off include, but are not limited to, connection 312 to electronic device 304 may become unreliable (e.g., signal strength of connection 312 is below a certain threshold or electronic device 304 is moving out of range for connection 312) or operating conditions of connection 318 may be higher than connection 312 (e.g., signal strength of connection 318 is higher than connection 312). According to some embodiments, electronic device 304 may determine that connection 312 has become unreliable or that connection 318 has better playback characteristics for streaming content 310A to electronic device 302. Based on this determination, electronic device 304 may determine that a transport hand-off should be performed to hand-off streaming of content 310A from connection 312 to connection 318. Alternatively, electronic device 302 may perform these determination steps.

According to some embodiments, electronic device 302 and/or electronic device 304 may determine that connection 312 is becoming unreliable by examining the signal strength of connection 312. If implemented as a Bluetooth connection, the signal strength of connection 312 may depend on the distance between electronic device 302 and electronic device 304 (such as the distance is nearing the maximum range for Bluetooth). Electronic device 302 and/or electronic device 304 may then examine available transport mediums having better playback characteristics, such as mediums having stronger signal strength or greater range, that can potentially provide a streaming session between electronic devices 302 and 304. These determinations are discussed in more detail with regard to FIG. 4.

If the determination is made that a transport hand-off should be performed to another transport medium, connection 318 may be established (if not already existing) and utilized between electronic device 302 and electronic device 304. Another streaming session may be initiated over connection 318, which allows electronic device 302 to continue streaming content 310A from electronic device 306. Once electronic device 302 begins streaming content 310A from electronic device 306 over connection 318, connection 312 may be terminated.

FIG. 3C is a block diagram that illustrates system 303, according to some embodiments of the disclosure. System 303 includes electronic device 302, electronic device 304, and electronic device 308. FIG. 3C illustrates a playback modality hand-off between electronic device 302 and electronic device 308.

Each of electronic devices 302, 304, and 308 may be implemented as a playback device and/or a source device such as, but are not limited to, set-top boxes, remote controllers, game controllers, wireless headphones, wireless speakers, cellular phones, smart phones, tablets, wearables, personal digital assistants (PDAs), or laptops. As an example, electronic device 308 may be considered a playback device, such as speakers 106. As previously discussed with regard to FIG. 3A, electronic device 302 may be considered a playback device such as headphones 104 and electronic device 304 may be considered a source device such as laptop 108.

There may be a connection 312 between electronic device 302 and electronic device 304, a connection 320 between electronic device 304 and electronic device 308, and a connection 322 between electronic device 302 and electronic device 308. Connections 312, 320, and 322 allow for the establishment content streaming sessions in which content may be streamed between electronic devices 302, 304, and 308. According to some embodiments, connections 312, 320, and 322 may be implemented using the same or different protocols that may include but are not limited to a cellular network connection (such as but not limited to UMTS or with LTE), a wireless local network connection (such as Wi-Fi, or based on Bluetooth or Bluetooth Low Energy), or another wireless connection. Although not illustrated, connections 312, 320, and 322 may include intermediary networking devices, such as access points, that may facilitate communications between electronic devices 302, 304, and 308.

In a streaming session over connection 312, electronic device 302 may initially stream content 310A from electronic device 304, During streaming of content 310A, electronic device 302 and/or electronic device 304 may detect a change in an operating condition of connection 312, connection 320, electronic device 302, electronic device 304, and/or electronic device 308. The change in the operating condition may require performing a playback hand-off whereby electronic device 304 transitions streaming content 310A from electronic device 302 to electronic device 308. There may be a preference or profile established by the user or the manufacturer of electronic devices 302, 304, and 308 that determines whether the change in the operating condition triggers the playback hand-off. Operating conditions include conditions regarding connection 312, electronic device 302, electronic device 304, connection 320, and/or electronic device 308. For example, operating conditions of connection 312 or 320 may include, but are not limited to, signal strength or throughput; operating conditions of electronic devices 302 and 308 may include, but are not limited to, a physical location of electronic devices 302 and 308, status (e.g., operating on AC or battery power, operating in sleep mode, battery life) of electronic devices 302 and 308, and physical characteristics (e.g., display size) of electronic devices 302 and 308; operating conditions of electronic device 304 may include, bin are not limited to, a physical location of electronic device 304, status (e.g., operating on AC or battery power, operating in sleep mode, battery life) of electronic device 304, or the type of content available to electronic device 304.

If the change in the operating condition triggers a playback modality band-off (e.g., the change in the operating condition exceeds a certain threshold), electronic device 302 and/or electronic device 304 may determine a new playback device (such as electronic device 308) for playing back content 310A from electronic device 304, Examples of thresholds that may trigger a playback hand-off include, but are not limited to, electronic device 302 may no longer be able to stream content 310A from electronic device 304 at a sufficient level (e.g., battery life of electronic device 302 is below a certain threshold such as 10%, electronic device 302 is initiating sleep or shut-down functions, etc.), electronic device 308 may have physical characteristics and conditions that allow it to stream content 310A at a higher level (e.g., display size of electronic device 308 may be larger than display size of electronic device 302), connection 312 to electronic device 304 is becoming unreliable (e.g., signal strength of connection 312 is below a certain threshold), operating conditions of connection 320 are higher than connection 312 (e.g., signal strength of connection 320 is higher than connection 312).

According to some embodiments, electronic device 304 may determine that connection 312 has become unreliable or that connection 320 is better able to stream content 310A to electronic device 302. Alternatively, or additionally, electronic device 302 may determine, by communication via connection 322, that electronic device 308 meets certain criteria (e.g., electronic device 308 may have a larger screen or may be capable of playing content 310A in high-definition) for playing back content 310A. Based on any of these as well as other determinations, electronic device 302 or electronic device 304, may determine that a playback hand-off should be performed to hand-off streaming of content 310A from electronic device 302 to electronic device 308.

If the determination is made that a playback hand-off should be performed and that electronic device 308 is selected as the new playback device, connection 320 may be established (if not already existing) and utilized between electronic device 304 and electronic device 308. A streaming session may be initiated over connection 320, which allows electronic device 308 to stream content 310A from electronic device 304. Once electronic device 308 begins streaming content 310A from electronic device 304, connection 312 may be terminated.

FIG. 4 illustrates timing and signaling for a content modality hand-off, according to some embodiments of the disclosure, including a hand-off involving the source for streaming content between electronic devices 302, 304, and 306. FIG. 4 shall be described with reference to FIG. 3A.

At 402, connection 312 between electronic device 302 and 304 may be established by

either electronic device 302 or electronic device 304.

At 404, electronic device 304 streams content 310A to electronic device 302 over connection 312. During this streaming session, electronic device 302, 304, and/or 306 may detect a change in an operating condition of the streaming session, wherein the change may involve the electronic device 302, electronic device 304, and/or the first connection 312 between these devices. The device that detects the change in the operating condition may then perform a comparison to a predetermined threshold in order to determine whether a source hand-off is appropriate.

If a source hand-off is appropriate (e.g., the change in operating condition exceeds a threshold), a hand-off message may be transmitted between electronic devices 302, 304, and/or 306. For example, at 406B, electronic device 304 may determine a source hand-off (e.g., from electronic device 304 to electronic device 306) is appropriate, and thus may transmit a hand-off message to electronic device 302. Alternatively, or additionally, at 406C, electronic device 304 may transmit the hand-off message to electronic device 306.

Alternatively, at 406B, electronic device 302 may detect a source hand-off is appropriate, and thus it may transmit a hand-off message to electronic device 304. Alternatively, or additionally, at 406A, electronic device 302 may transmit the hand-off message to electronic device 306. Alternatively, or additionally, at 406C, electronic device 306 may transmit the hand-off message to electronic device 304.

The hand-off message transmitted by any one of electronic devices 302, 304, and/or 306 may include information that allows electronic device 302 to stream content from electronic device 306 at the same point when hand-off between electronic device 304 and electronic device 306 occurs. In some embodiments, the hand-off message may include playback information that identifies the content to be streamed, the timestamp of the content at which to begin streaming content from electronic device 306 to electronic device 302, and/or identification of a second connection through which the content may be streamed. For example, if electronic device 302 is streaming an audio file, and the hand-off of the stream between electronic device 304 and electronic device 306 takes place at 2 minutes and 30 seconds in the audio file, the hand-off message may include information that identifies the audio file and the time stamp (e.g., 2 minutes and 30 seconds). Using information in the hand-off message, electronic device 302 may continue streaming the audio file at the same timestamp from electronic device 306 using the second content streaming session without any interruption or discontinuity of the stream daring the hand-off.

At 408, connection 314 between electronic device 302 and electronic device 306 may be established. At 410, electronic device 302 may stream content from electronic device 306 using the second connection 314.

At 412, connection 312 between electronic device 302 and 304 may be terminated.

FIG. 5 illustrates timing and signaling of a modality hand-off, according to some

embodiments of the disclosure including a hand-off involving the transport modality for streaming content between electronic devices 302 and 304, FIG. 5 shall be described with reference to FIG. 3B.

At 502, electronic device 302 and/or electronic device 304 may establish a first connection 312. At 504, electronic device 304 streams content 330A to electronic device 302 over the first connection 312. During this streaming session, electronic device 302 and/or 304 may detect a change in an operating condition of the streaming session involving the electronic device 302, electronic device 304, and/or connection 312. The device that detects the change in the operating condition may then perform a comparison to a predetermined threshold in order to determine whether a transport hand-off is appropriate.

If a transport hand-off is appropriate (e.g., change In operating condition exceeds a threshold), then at 506, a hand-off message may be transmitted between electronic devices 302 and 304. According to some embodiments, the hand-off message indicates that a hand-off is to take place. For example, at 506, electronic device 304 may determine a transport hand-off (e.g., from connection 312 involving a first transport medium to connection 318 involving a second transport medium) is appropriate, and thus may transmit a hand-off message to electronic device 302 to signal that the hand-off should take place. Alternatively, electronic device 302 may detect a transport hand-off is appropriate, and thus may transmit the hand-off message to electronic device 304 that the hand-off should take place.

At 508, second connection 318 between electronic device 302 and electronic device 304 may be established (if not already established). At 510, electronic device 302 may stream content 310A from electronic device 304 using second connection 318.

At 512, connection 312 between electronic device 302 and 304 may be terminated.

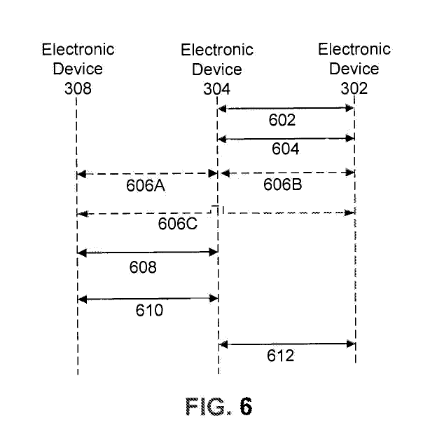

FIG. 6 illustrates timing and signaling of a modality hand-off, according to some embodiments of the disclosure, including a hand-off involving the playback modality for streaming content between electronic devices 302, 304, and 308, FIG. 6 shall be described with reference to FIG. 3C.

At 602, electronic device 302 and electronic device 304 may establish connection 312. At 604, electronic device 304 streams content 310A to electronic device 302 over connection 312. During this streaming session, electronic device 302 and/or electronic device 304 (and/or electronic device 308) may detect a change in an operating condition of the streaming session involving the electronic device 302, electronic device 304, electronic device 308, and/or connection 312. The device that detects the change in the operating condition may then perform a comparison to a predetermined threshold in order to determine whether a playback hand-off is appropriate. If a playback hand-off is appropriate, a hand-off message may be transmitted between electronic devices 302, 304, and/or 308. For example, at 606B, electronic device 304 may detect a playback hand-off (e.g., from electronic device 302 to electronic device 308) is appropriate, and thus may transmit a hand-off message to electronic device 302 indicating that the hand-off should be performed. Alternatively, or additionally, at 606A, electronic device 304 may transmit the hand-off message to electronic device 308.

Alternatively, at 606B, electronic device 302 may detect a playback hand-off is appropriate, and thus may transmit a hand-off message to electronic device 304. Alternatively, or additionally, at 606C, electronic device 302 may transmit the hand-off message to electronic device 308. Alternatively, at 606C, electronic device 308 may detect a playback hand-off is appropriate, and thus may transmit a hand-off message to electronic device 302. Alternatively, or additionally, at 606A, electronic device 308 may transmit the hand-off message to electronic device 304.

In some embodiments, the hand-off message transmitted by electronic devices 302, 304, and/or 308 may include information that allows electronic device 308 to stream content from electronic device 304 at the same point in content 310A when transitioning the streaming content from electronic device 302 to electronic device 308. In some embodiments, the hand-off message may include playback information identifying the content to be streamed, the timestamp of the content at which to electronic device 308 should begin streaming content from electronic device 304, and/or an identification of the second connection to be established through which the content may be streamed. For example, if electronic device 302 is streaming an audio file, and the hand-off of the stream between electronic device 302 and electronic device 308 takes place at 2 minutes and 30 seconds in the audio file, the hand-off message includes an identifier for the audio file and the time stamp (e.g., 2 minutes and 30 seconds). Using information in the hand-off message, electronic device 308 may continue streaming the audio file at the same time stamp from electronic device 304 using the second content streaming session without any interruption of the stream during the hand-off.

At 608, second connection 320 between electronic device 304 and electronic device 308 may be established (if not already existing). At 610, electronic device 308 may stream content 310A from electronic device 304 using second connection 320. At 612, connection 312 may be terminated.

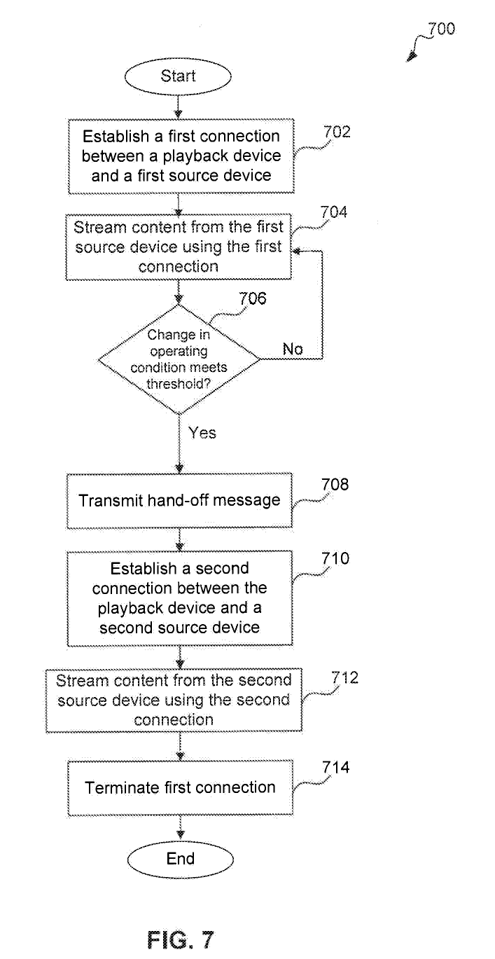

FIG. 7 illustrates a method 700 for a source modality hand-off, according to some embodiments of the disclosure. This disclosure is not limited to this operational description. Rather, it will be apparent to persons skilled in the relevant art(s) from the teachings herein that other operational control flows are within the spirit and scope of the present disclosure. It is to be appreciated that additional operations may be performed. Moreover, not all operations may be needed to perform the disclosure provided herein. Further, some of the operations may be performed simultaneously, or in a different order than shown in FIG. 7, as will be understood by a person of ordinary skill in the art, Some operations can be combined with operations of methods from other figures and/or performed as a single operation. In some implementations, one or more other operations may be performed in addition to or in place of the presently described operations. For illustrative purposes, method 700 is described with reference to the embodiment of FIG. 3A. However, method 700 is not limited to this embodiment.

At 702, a first connection is established between a playback device and a first source device that has access to content to be streamed, to the playback device. As described above with regard to FIG. 3A, the playback device may be implemented as electronic device 302, the first source device may be implemented as electronic device 304, and the first connection may be implemented as connection 312. However, it is to be appreciated that the playback device and first source device may be implemented as any type of electronic device that is capable of streaming content over a connection, and playing back such content.

At 704, electronic device 304 streams content 310A to electronic device 302 over connection 312.

At 706, during streaming of content 310A, electronic device 302 and/or electronic device 304 (and/or electronic device 306) may monitor for changes to operating conditions of the electronic device 302, electronic device 304, electronic device 306, and connection 312. Any change to operating conditions may be compared with a predetermined threshold associated with the operation conditions to determine whether a source modality hand-off is appropriate.

If there is no change in operating conditions relating to source modality hand-off or if the change does not meet the predetermined threshold, content 310A may continue to be streamed using connection 312 at 704.

But if at 706 electronic device 302, 304, and/or 306 determines there is a change in operating condition(s) that triggers a source modality hand-off, then at 708 a hand-off message may be transmitted between electronic devices 302, 304, and the second source device (such as electronic device 306) to initiate hand-off of content 310A. The hand-off message may be transmitted to any or each electronic device 302, 304, and/or 306 to signal that a hand-off is appropriate. According to some embodiments, the hand-off message may be transmitted by electronic device 302 or electronic device 304. The hand-off message may include playback information, such as identification of content 310A, a timestamp of content 310A indicating the position at which content 310A was being streamed from electronic device 304 to electronic device 302 at the time of the hand-off, and/or the identification of second connection 314 to be established through which content 310B may be streamed. The information in the hand-off message enables electronic device 302 to stream content 310B from electronic device 306 at the same position of content 310A at the time the transition from electronic device 304 to electronic device 306 took place.

At 710, based on the playback information in the hand-off message, a second connection (such as connection 314) may be established between electronic device 302 and the second source device (such as electronic device 306).

At 712, content 310B may be streamed to electronic device 302 from the electronic device 306 over a second content streaming session using connection 314 at the same point in the content at which the streaming session transitioned from connection 312 to connection 314. At 714, connection 312 may be terminated.

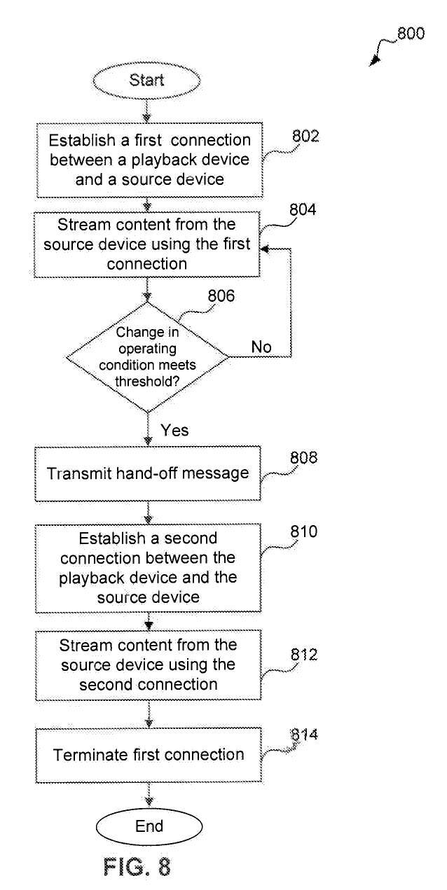

FIG. 8 illustrates a method 800 for a transport modality hand-off according to some embodiments of the disclosure. This disclosure is not limited to this operational description. Rather, it will be apparent to persons skilled in the relevant art(s) from the teachings herein that other operational control flows are within the spirit, and scope of the present disclosure. It is to be appreciated that additional operations may be performed. Moreover, not all operations may be needed to perform the disclosure provided herein. Further, some of the operations may be performed simultaneously, or in a different order than shown in FIG. 8, as will be understood by a person of ordinary skill in the art. Some operations can be combined with operations of methods from other figures and/or performed as a single operation. In some implementations, one or more other operations may be performed in addition to or in place of the presently described operations. For illustrative purposes, method 800 is described with reference to the embodiment of FIG. 3B. However, method 800 is not limited to this embodiment.

At 802, a first connection is established between a playback device and a source device providing access to content. As described above with regard to FIG. 3B, the playback device may be implemented as electronic device 302, the source device may be implemented as electronic device 304 (providing access to content 310A), and the first connection may be implemented as connection 312. However, it is to be appreciated that the playback device and first source device may be implemented as any type of electronic device that is capable of streaming content over a connection, and playing back such content.

At 804, electronic device 304 streams content 310A to electronic device 302 over the first connection 312.

At 806, during streaming of content 310A, electronic device 302 and/or electronic device 304 may monitor operating conditions of electronic device 302, electronic device 304, and connection 312. Any change to operating conditions may be compared with a predetermined threshold to determine whether a transport medium modality hand-off is appropriate.

If there is no change in operating conditions relating to transport modality hand-off or if the change in operating conditions does not meet the predetermined threshold, content 310A may continue to be streamed using the first content streaming session at 804.

But if electronic device 302 and/or electronic device 304 at 806 determines there is a change in operating condition(s) that triggers a transport modality hand-off, then at 808 a hand-off message is transmitted between electronic devices 302 and 304 to indicate that, a hand-off is appropriate. The hand-off message may be a notification that hand-off is being initiated.

At 810, a second connection (such as connection 318) between electronic device 302 and electronic device 304 may be established. At 812, content 310A may be streamed to electronic device 302 from electronic device 304 using the second content streaming session over connection 318 at the same point in the content at which the streaming session transitioned from connection 312 to connection 318. At 814, connection 312 may be terminated.

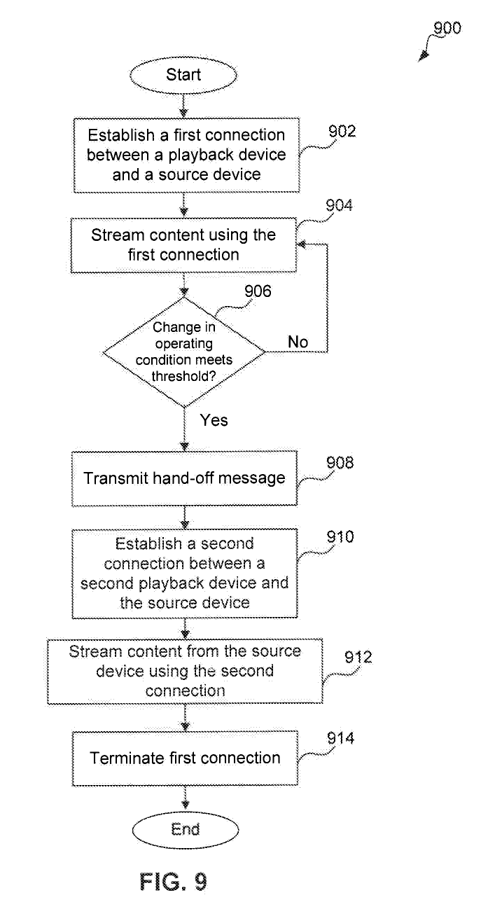

FIG. 9 illustrates a method 900 for a playback modality hand-off, according to some embodiments of the disclosure. This disclosure is not limited to this operational description. Rather, it will be apparent to persons skilled in the relevant art(s) from the teachings herein that other operational control flows are within the spirit and scope of the present disclosure. It is to be appreciated that additional operations may be performed. Moreover, not all operations may be needed to perform the disclosure provided herein. Further, some of the operations may be performed simultaneously, or in a different order than shown in FIG. 9, as will be understood by a person of ordinary skill in the art. Some operations can be combined with operations of methods from other figures and/or performed as a single operation, in some implementations, one or more other operations may be performed in addition to or in place of the presently described operations. For illustrative purposes, method 900 is described with reference to the embodiment of FIG. 3C. However, method 900 is not limited to this embodiment.

At 902, a first connection is established between a playback device and a first source device. As described above with regard to FIG. 3C, the playback device may be implemented as electronic device 302, the source device may be implemented as electronic device 304 (providing access to content 310A), and the first connection may be implemented as connection 312. However, it is to be appreciated that the playback device avid first source device may be implemented as any type of electronic device that is capable of streaming content over a connection, and playing back that content.

At 904, electronic device 304 streams content 310A to the electronic device 302 over connection 312.

At 906, during streaming of content 310A, electronic device 302 and/or electronic device 304 (and/or electronic device 308) may monitor operating conditions of the electronic device 302, electronic device 304, electronic device 308, connection 312, and/or connection 320 (if already established). Any change to operating conditions may be compared with a predetermined threshold to determine whether a playback modality hand-off is appropriate.

If there is no change in operating conditions relating to playback modality hand-off or the change in operating conditions does not meet the predetermined threshold, content 310A may continue to be streamed using connection 312 at 904.

But if, at 906, electronic device 302, 304, and/or 306 determines there is a change in operating condition(s) that triggers a playback modality hand-off then at 908 a hand-off message is transmitted between electronic devices 302, 304, and a second playback device (such as electronic device 308) to initiate hand-off of content 310A. According to some embodiments, the hand-off message may be transmitted by electronic device 302, electronic device 304, and/or electronic device 308. The hand-off message may include playback information, such as identification of content 310A and a timestamp of content 310A indicating the position at which content 310A is to be streamed after transitioning the destination of streaming content from electronic device 302 to electronic device 308.

At 910, based on the playback information in the hand-off message, a second connection (such as connection 320) between the electronic device 308 and electronic device 304 is established. At 912, content 310A may be streamed to electronic device 308 from electronic device 304 over connection 320. At 912, connection 312 may be terminated.

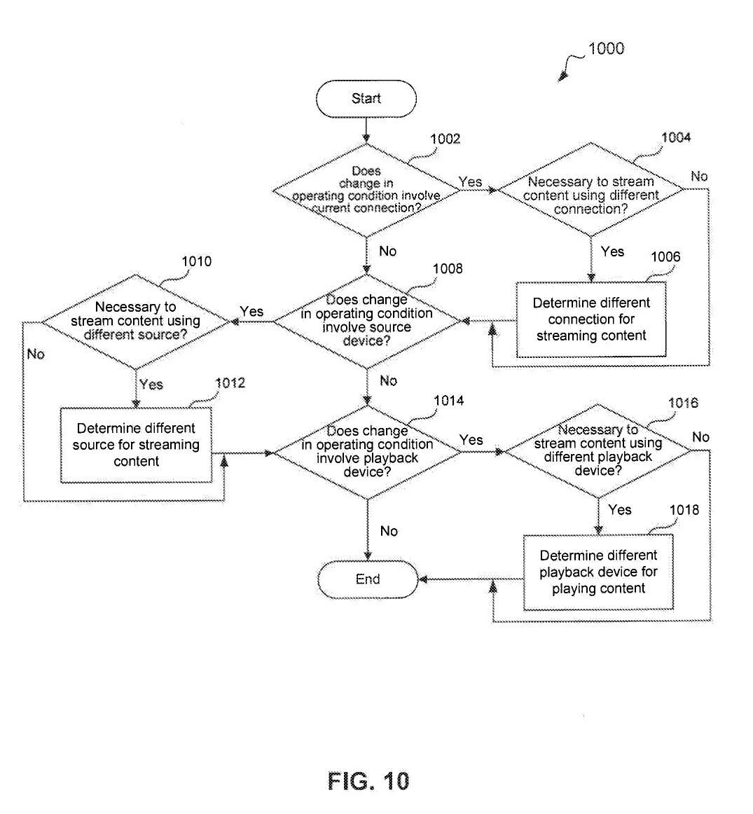

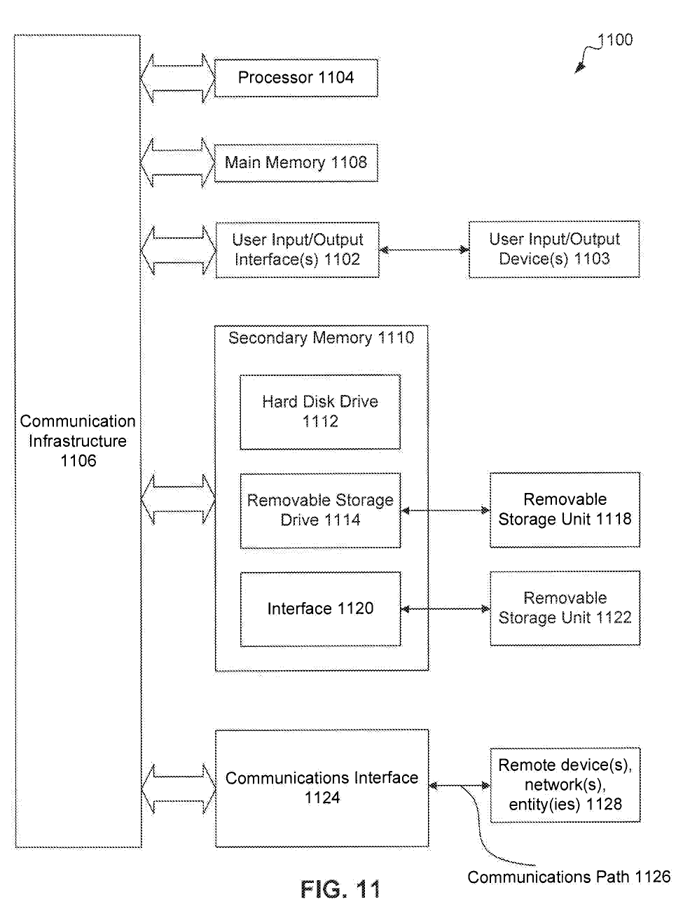

The source, transport medium, and playback modality hand-offs as described above with regard to FIGS. 7-9 may be combined in any way such that a system checks one, two, or all three hand-offs. FIG. 10 illustrates a method 1000 illustrating source, transport, and playback modality hand-off. This disclosure is not limited to this operational description. Method 1000 may be implemented by any electronic device that is capable of streaming and/or playing content. For example, method 1000 may be performed by tablet 102, headphones 104, speakers 106, or laptop 108. Rather, it will be apparent to persons skilled in the relevant art(s) from the teachings herein that other operational control flows are within the spirit and scope of the present disclosure. It is to be appreciated that additional operations may be performed. Moreover, not all operations may be needed to perform the disclosure provided herein. Further, some of the operations may be performed simultaneously, or in a different order than shown in FIG. 10, as will be understood by a person of ordinary skill in the art. Some operations can be combined with operations of methods from other figures and/or performed as a single operation. In some implementations, one or more other operations may be performed in addition to or in place of the presently described operations. For illustrative purposes, method 1000 is described with reference to the embodiment of FIG. 1. However, method 1000 is not limited to this embodiment. Also, method 1000 of FIG. 10 may be extended to other modality hand-offs, wherein such other modality hand-offs will be apparent to persons skilled in the art based on the teachings provided herein.

At 1002, headphones 104 and/or laptop 108 of system 100 may determine whether a change in operating condition(s) involves a current connection that is streaming content, such as connection 112. Operating conditions of first connection 112 may relate to network performance of connection 112 (such as signal strength, throughput, or bandwidth).

At 1004, if the change involves connection 112, headphones 104 and/or laptop 108 may determine whether the change triggers a transport medium hand-off. According to some embodiments, a change triggers a transport hand-off when the change meets or exceeds a certain threshold. For example, a threshold may refer to a certain level for the signal strength of connection 112.

At 1006, if a transport medium hand-off is triggered, headphones 104 and/or laptop 108 may determine whether a different connection is available for streaming content. For example, connection 114 may be determined to be available and provide better playback characteristics over connection 112. Accordingly, the streaming session may be switched from connection 112 to connection 114.

At 1008, if the change does not involve connection 112 or if a transport medium hand-off is not triggered, headphones 104 and/or laptop 108 may next determine whether the change in operating condition involves a source device, such as laptop 108 and/or tablet 102. Operating conditions of laptop 108 may relate to operating status (e.g., battery life, the laptop is transitioning to sleep or shutdown mode) or characteristics of the streaming content accessible to laptop 108 (e.g., bit-rate or resolution). Alternatively, it may be determined that another source device, such as tablet 102, provides access to content having better playback characteristics (such as higher bit-rate or resolution) than the currently streamed content.

At 1010, if the change involves laptop 108 or tablet 102, any of tablet 102, headphones 104, and/or laptop 108 may determine whether the change triggers a source hand-off According to some embodiments, a change triggers a source hand-off when the change meets or exceeds a certain threshold. For example, a threshold may refer to a certain level of battery life for laptop 108, or laptop 108 is transitioning to a sleep or shutdown mode. In other embodiments, there may be a preference or profile established by user or the manufacturer of tablet 102, headphones 104, and laptop 108 that determines whether the change in the operating condition triggers the source hand-off.

At 1012, if a source hand-off is triggered, any of tablet 102, headphones 104, and/or laptop 108 may determine a different source device for streaming content to headphones 104. For example, tablet 102 may be determined to be available and provide access to the same content but having better playback characteristics to headphones 104. Accordingly, the source for streaming content may be switched from laptop 108 to tablet 102.

At 1014, if the change does not involve laptop 108 or if a source hand-off is not triggered, headphones 104, speakers 106, and/or laptop 108 may next determine whether the change in operating condition involves a playback device, such as headphones 104 and/or speakers 106. Operating conditions of headphones 104 may rotate to operating status (e.g., battery life, or headphones may be transitioning to sleep or shutdown mode) and operation conditions of speakers may relate to playback capability (e.g., speakers may be better capable of playing the content).

At 1016, if the change involves the playback device, such as headphones 104 and/or speakers 106, any of headphones 104, speakers 106 and/or laptop 108 may determine whether the change triggers a playback hand-off. According to some embodiments, a change triggers a playback hand-off when the change meets or exceeds a certain threshold. For example, a threshold may refer to a certain level of headphones 104's battery life, or if headphones 104 is transitioning to a sleep or shutdown mode.

At 1018, if a playback hand-off is triggered, any of headphones 104, speakers 106 and/or laptop 108 may determine a different playback device for streaming content from laptop 108. For example, speakers 106 may be determined to be available and capable of playing back the same content having better playback characteristics than headphones 104. In other embodiments, there may be a preference or profile established by user or the manufacturer of headphones 104, speakers 106, and/or laptop 108 that may determine whether the change in the operating condition triggers the playback hand-off. Accordingly, the playback device may be switched from headphones 104 to speakers 106.

Various embodiments can be implemented, for example, using one or more computer systems, such as computer system 1100 shown in FIG. 11. Computer system 1100 can be any well-known computer capable of performing the functions described herein. For example, and without limitation, electronic devices 302, 304, 306, and 308 (and/or other apparatuses and/or components shown in the figures) and flowcharts of FIGS. 2 and 7-10 may be implemented using one or more computer systems 1100, or portions thereof.

Computer system 1100 includes one or more processors (also called central processing units, or CPUs), such as a processor 1104. Processor 1104 is connected to a communication infrastructure or bus 1106.

Computer system 1100 also includes user input/output device(s) 1103, such as monitors, keyboards, pointing devices, etc., that communicate with communication infrastructure 1106 through user input/output interface(s) 1102.

Computer system 1100 also includes a main or primary memory 1108, such as random access memory (RAM). Main memory 1108 may include one or more levels of cache. Main memory 1108 has stored therein control logic (i.e., computer software) and/or data.

Computer system 1100 may also include one or more secondary storage devices or memory 1110. Secondary memory 1110 may include, for example, a hard disk drive 1112 and/or a removable storage device or drive 1114. Removable storage drive 1114 may be a floppy disk drive, a magnetic tape drive, a compact disk drive, an optical storage device, tape backup device, and/or any other storage device/drive.

Removable storage drive 1114 may interact with a removable storage unit 1118. Removable storage unit 1118 includes a computer usable or readable storage device having stored thereon computer software (control logic) and/or data. Removable storage unit 1118 may be a floppy disk, magnetic tape, compact disk, DVD, optical storage disk, and/any other computer data storage device. Removable storage drive 1114 reads from and/or writes to removable storage unit 1118 in a well-known manner.

According to an exemplary embodiment, secondary memory 1110 may include other means, instrumentalities or other approaches for allowing computer programs and/or other instructions and/or data to be accessed by computer system 1100. Such means, instrumentalities or other approaches may include, for example, a removable storage unit 1122 and an interface 1120. Examples of the removable storage unit 1122 and the interface 1120 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1100 may further include a communication or network interface 1124. Communication interface 1124 enables computer system 1100 to communicate and interact with any combination of remote devices, remote networks, remote entities, etc. (individually and collectively referenced by reference number 1128). For example, communication interface 1124 may allow computer system 1100 to communicate with remote devices 1128 over communications path 1126, which may be wired and/or wireless, and which may include any combination of LANs, WANs, the Internet, etc. Control logic and/or data may be transmitted to and from computer system 1100 via communication path 1126.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 1100, main memory 1108, secondary memory 1110, and removable storage units 1118 and 1122, as well as tangible, non-transitory articles of manufacture embodying any combination of the foregoing. Such control logic, when executed by one or more data processing devices (such as computer system 1100), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 11. In particular, embodiments may operate with software, hardware, and/or operating system implementations other than those described herein.

It is to be appreciated that the Detailed Description section, and not fee Summary and Abstract sections, is intended to be used to interpret the claims. The Summary and Abstract, sections may set forth one or more but not all exemplary embodiments of this disclose, and thus, are not intended to limit this disclosure or the appended claims in any way.

While this disclosure has been described herein with reference to exemplary embodiments for exemplary fields and applications, it should be understood that this disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative embodiments may perform functional blocks, steps, operations, methods, etc. using orderings different from those described herein.

References herein to “one embodiment,” “an embodiment.” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of this disclosure should not be limited by any of the above-described exemplary embodiments, but should be defined only in accordance with the following claims and their equivalents.

What is claimed is:

1. A method for intelligent hand-off, comprising:
transmitting first content from a first source device to a playback device over a first connection;
detecting a change in an operating condition of at least one of the first connection, the playback device, the first source device, and a second source device, wherein the second source device has access to second content;
based on at least detecting the change in the operating condition, transitioning from the first source device to the second source device, to transmit the second content to the playback device, wherein the transitioning includes utilizing a second connection between the playback device and the second source device; and
transmitting the second content from the second source device to the playback device over the second connection at a point in the first content corresponding to the transitioning from the first source device to the second source device.

2. The method of claim 1, wherein detecting the change in the operating condition comprises:
detecting at least one of a first transmission quality of the first connection, a second transmission quality of the second connection, a first operating status of the first source device, a second operating status of the second source device, a playback quality of the second content, and a physical location of the playback device.

3. The method of claim 1, wherein detecting the change in the operating condition comprises:
comparing the change in the operating condition to a threshold value; and
initiating the transitioning from the first source device to the second source device based at least on the comparing, wherein the initiating includes transmitting a hand-off message to at least one of the first source device, the second source device, and the playback device.

4. The method of claim 3, wherein transmitting the second content comprises:
utilizing information in the hand-off message, wherein the information includes an identifier for the first content and a timestamp indicating the point in the first content corresponding to the transitioning from the first source device to the second source device.

5. The method of claim 1, wherein the first connection utilizes a first transport medium and the second connection utilizes a second transport medium, the first transport medium being different from the second transport medium.

6. The method of claim 1, further comprising:
establishing the second connection prior to the detecting the change in the operating condition.
7. The method of claim 1, wherein the transitioning from the first source device to the second source device is in response to a playback quality of the second content being preferred over a playback quality of the first content.

8. A method for intelligent hand-off, comprising:
transmitting content from a source device to a playback device over a first connection; detecting a change in an operating condition of at least one of the first connection, the playback device, and the source device;
based on at least detecting the change in the operating condition, transitioning from the first connection to a second connection, wherein the transitioning includes utilizing the second connection between the playback device and the source device; and
transmitting the content from the source device to the playback device over the second connection at a point in the content corresponding to the transitioning from the first connection to the second connection.

9. The method of claim 8, wherein detecting the change in the operating condition further comprises:
detecting at least one of a first transmission quality of the first connection, a second transmission quality of the second connection, an availability of the second connection, an operating status of the source device, and a physical location of the playback device.

10. The method of claim 8, further comprising:
comparing the change in the operating condition to a threshold value; and
initiating the transitioning from the first connection to the second connection based at least on the comparing, wherein the initiating includes transmitting a hand-off message to at least one of the source device and the playback device.

11. The method of claim 10, wherein transmitting the content comprises:
utilizing information in the hand-off message, wherein the information includes an identification of the second connection.

12. The method of claim 8, wherein the first connection utilizes a first transport medium and the second connection utilizes a second transport medium, the first transport medium being different from the second transport medium.

13. The method of claim 8, wherein the second connection is established prior to the detecting the change in the operating condition.

14. The method of claim 8, wherein the transitioning from the first connection to the second connection is in response to a second transmission quality of the second connection being preferred over a first transmission quality of the first connection.

15. A method for intelligent hand-off, comprising:
transmitting content from a source device to a first playback device over a first connection;
detecting a change in an operating condition of at least one of the first connection, the first playback device, the source device, and a second playback device;
based on at least detecting the change in the operating condition, determining that the content is to be streamed from the source device to the second playback device;
based on at least determining that the content is to be streamed from the source device to the second playback device, transitioning to transmitting the content from the first playback device to the second playback device to receive the content from the source device, wherein the transitioning includes utilizing a second connection between the second playback device and the source device; and
transmitting the content from the source device to the second playback device over the second connection at a point in the content corresponding to the transitioning.

16. The method of claim 15, wherein detecting the change in the operating condition comprises:
detecting at least one of a first transmission quality of the first connection, a second transmission quality of the second connection, a first operating status of the source device, a second operating status of the first playback device, a third operating status of the second playback device, a first physical location of the first playback device, and a second physical location of the second playback device.

17. The method of claim 15, wherein detecting the change in the operating condition comprises:
comparing the change in the operating condition to a threshold value; and
initiating the transitioning from the first playback device to the second playback device based at least on the comparing, wherein the initiating includes transmitting a hand-off message to at least one of the first playback device, the second playback device, and the source device.

18. The method of claim 17, wherein transmitting the content comprises:
utilizing information in the hand-off message, wherein the information includes an identifier for the content and a timestamp indicating the point in the content corresponding to the transitioning from the first playback device to the second playback device.

19. The method of claim 15, wherein the first connection utilizes a first transport medium and the second connection utilizes a second transport medium, the first transport medium being different from the second transport medium.

20. The method of claim 15, wherein the second connection is established prior to the detecting the change in the operating condition.
